(19) United States
(12) Patent Application Publication
(10) Pub. No.: US 2012/0166501 A1
(43) Pub. Date: Jun. 28, 2012

(54) COMPUTATION OF JACOBIAN LOGARITHM OPERATION

(76) Inventors: Andrey P. Sokolov, Moscow (RU); Sergey B. Gashkov, Moscow (RU); Elyar E. Gasanov, Moscow (RU); Pavel A. Panteleev, Moscow (RU); Ilya V. Neznanov, Moscow (RU)

(21) Appl. No.: 13/197,098

(22) Filed: Aug. 3, 2011

(30) Foreign Application Priority Data
Dec. 24, 2010 (RU) 2010152794

(51) Int. Cl. G06F 7/483

(52) U.S. Cl. 708/201

(57) ABSTRACT

An apparatus generally having a first circuit, a second circuit and a third circuit is disclosed. The first circuit may be configured to generate a plurality of first signals carrying (i) a maximum value among a plurality of input values and (ii) a plurality of difference values based on the input values. The second circuit may be configured to generate a plurality of second signals carrying a plurality of intermediate values based on the difference values. The intermediate values are generally respective powers of two. The third circuit may be configured to generate a third signal carrying an output value by adding the maximum value and the intermediate values. The output value may be a Jacobian logarithm computation of the input values.

This application claims the benefit of Russian Application No. 2010152794, filed Dec. 24, 2010 and is hereby incorporated by reference in its entirety.

### FIELD OF THE INVENTION

The present invention relates to wireless communications generally and, more particularly, to a method and/or apparatus for implementing computation of a Jacobian logarithm operation.

### BACKGROUND OF THE INVENTION

Conventional schemes that compute a Jacobian logarithm operation commonly have a big depth. The depth limits clock frequencies on which the conventional schemes can run, which in turn restrict an overall speed of a decoder in which the max* operation is implemented. The Jacobian logarithm operation is commonly referred to as a max* operation. The max* operation is computed according to formula 1 as follows:

max*(a,b)=ln(e^{a}+e^{b}) (1)

where a and b are real numbers. The max* operation was originally defined by Andrew J. Viterbi in 1998.

The max* operation may be rewritten per formula 2 as follows:

max*(a,b)=max(a,b)+ln(1+e^{-d}) (2)

where d=max(a,b)−min(a,b). Decoders typically deal with fixed point numbers. When implemented as hardware, operations ln(X) and e^{X} have significant depths that limit maximal clock frequency on which the hardware can operate.

If a and b are significantly different from each other, the e^{-d} term is negligible. Therefore, a common way to decrease the depth is to use an approximate computation of the max* operation. A commonly used approximation of the max* operation is according to formula 3 as follows:

max*(a,b)≈max(a,b) (3)

The depth of a scheme that implements the max operation is less than the depth for the max* operation case. Therefore, a clock frequency of the max operation case is higher that the max* operation case. Modification of a Logarithmic-Maximum A Posteriori decoding (LOG-MAP) technique with the approximate max* operation is usually called a MAX-Log-MAP technique. A disadvantage of the MAX-Log-MAP technique is a degradation in decoding quality compared with pure a Log-MAP technique. For certain bit error rates, a signal-to-noise ratio of the MAX-Log-MAP technique is about 0.5 dB higher than for the pure Log-MAP technique.

Referring to FIG. 1, a block diagram of a conventional circuit 10 implementing a Jacobian logarithm operation computation is shown. A circuit 12 receives multiple input values (i.e., a and b) and calculates a maximum value (i.e., max(a,b)) and a difference value (i.e., d). A circuit 14 contains a lookup table that presents the value ln(1+e^{-d}). A circuit 16 adds the maximum value max(a,b) to the value ln(1+e^{-d}) to generate an approximate value max*(a,b). The circuit 10 takes at least two clock cycles to compute the approximate value max*(a,b). The lookup table memory in the circuit 14 takes a clock cycle and the adder in the circuit 16 takes another clock cycle.

### SUMMARY OF THE INVENTION

The present invention concerns an apparatus generally having a first circuit, a second circuit and a third circuit. The first circuit may be configured to generate a plurality of first signals carrying (i) a maximum value among a plurality of input values and (ii) a plurality of difference values based on the input values. The second circuit may be configured to generate a plurality of second signals carrying a plurality of intermediate values based on the difference values. The intermediate values are generally respective powers of two. The third circuit may be configured to generate a third signal carrying an output value by adding the maximum value and the intermediate values. The output value may be a Jacobian logarithm computation of the input values.

The objects, features and advantages of the present invention include providing a method and/or apparatus for implementing computation of the Jacobian logarithm operation that may (i) give decoding quality comparable with the quality of a pure Log-MAX technique, (ii) implement the max* operation with a low depth compared with conventional techniques, (iii) compute the max* operation in less than two clock cycles, (iv) implement fully combinational logic for high speed operation, (v) incorporate ring oscillators and/or pseudo-random binary string generators to increase decoding quality where fixed point numbers are used and/or (vi) calculate a maximum value and multiple additive terms in a single circuit.

### BRIEF DESCRIPTION OF THE DRAWINGS

These and other objects, features and advantages of the present invention will be apparent from the following detailed description and the appended claims and drawings in which:

FIG. 1 is a block diagram of a conventional circuit implementing the Jacobian logarithm operation computation;

FIG. 2 is a block diagram of an apparatus in accordance with an example embodiment of the present invention;

FIG. 3 is a detailed block diagram of an implementation of a maximum and absolute difference calculator circuit;

FIG. 4 is a detailed block diagram of an implementation of a ring oscillator circuit; and

FIG. 5 is a detailed block diagram of an implementation of a shifter circuit.

### DETAILED DESCRIPTION OF THE PREFERRED EMBODIMENTS

Some embodiments of the present invention may provide an approximate computation of the Jacobian logarithm (or max*) operation at high frequencies. The computation may be useful in the Logarithmic-Maximum A Posteriori decoding (LOG-MAP) technique used for decoding of the turbo codes. The codes may be used in many modern wireless communications standards. The wireless communications standards may include, but are not limited to, a Long Term Evolution (LTE) standard (3GPP Release 8), an Institute of Electrical and Electronics Engineering (IEEE) 802.16 standard (WiMAX), a Wideband-CDMA/High Speed Packet Access (WCDMA/HSPA) standard (3GPP Release 7) and a CDMA-2000/Ultra Mobile Broadband (UMB) standard (3GPP2). Other wired and/or wireless communications standards may be implemented to meet the criteria of a particular application. Log-MAP decoding may be organized in such manner that a decoding speed may be determined by speed of the max* operation.

For a pair of input values a and b, the max* operation may be defined by formula 1 above. An approximation of the max* operation in some embodiments of the present invention may be defined by formula 4 as follows:

max*(a,b)≈max(a,b)+e^{-d}≈max(a,b)+2^{-(d+1)} (4)

where the value d=max(a,b)−min (a,b), the max (maximum) operation returns the maximum value of a or b and the min (minimum) operation returns the minimum value of a or b. Therefore, the value d may be an absolute value of a difference between a and b.

For simpler implementation, the value d in the exponent may be truncated (floor) to a nearest integer value. Therefore, the max* operation may be approximated according to formula 5 as follows:

max*(a,b)≈max(a,b)+2^{-([d]+1)} (5)

where the operation [d] returns a largest integer less than or the same as the value d (e.g., truncation).

Because the value d may be truncated to a lesser value, some degradation of the decoding quality generally takes place. To decrease an impact of the effect, a random number (e.g., r) may be added to the exponent. The random number r may have either a zero (0) value or a one (1) value. The random number generally allows the decoding to achieve a quality comparable with the pure Log-MAP technique. Incorporating the random number value into the approximation of the max* operation results in formula 6 as follows:

max*(a,b)≈max(a,b)+2^{-([d]+r+1)} (6)

where rε{0,1} may be a uniformly distributed random number. The random number r may be generated by a ring oscillator, a pseudo-random binary sequence generator (PRBS) and/or other random number generator (RNG). If the value of the random number r=1, adding 1 to the exponent in formula 6 may be viewed as a division of number 2^{-([d]+1)} by 2, or a shift of the binary number to the left a single digit. Such a shifting operation is relatively simple concerning the depth. Therefore, the overall depth of the scheme for formula 6 becomes comparable to that of a simple max operation. If the value of the random number r=0, adding 0 to the exponent in formula 6 does not change the number 2^{-([d]+1)}.

Cases generally exist for fast decoding of turbo codes where the max* operation depends on four arguments. A four-argument approximation of the max* operation may be defined by formulae 7 to 11 as follows:

$$\begin{matrix}{max}^{*} ( x , y , z , t ) = {max}^{*} ( {max}^{*} ( x , y ) , {max}^{*} ( z , t ) ) \\ = max ( x , y , z , t ) + ln ( 1 + {e}^{- d 1} + {e}^{- d 2} + {e}^{- d 3} )\end{matrix} \qquad ( 7 )$$

where

d1=max(x,y,z,t)−p (8)

d2=max(x,y,z,t)−q (9)

d3=max(x,y,z,t)−s (10)

{p,q,s}={x,y,z,t}\max(x,y,z,t) (11)

The notation of formula 11 generally means that the set {p,q,s} is obtained by subtracting the value max(x,y,z,t) from the set {x,y,z,t}. Therefore, {p,q,s} may be the three smallest elements from the set {x,y,z,t}. Application of the above to the approximation may take the form according to formula 12 as follows:

max*(x,y,z,t)≈max(x,y,z,t)+2^{-([d1]+r1+1)}+2^{-([d2]+r2+1)}+2^{-([d3]+r3+1)} (12)

where r1, r2, r3ε{0,1} may be uniformly distributed random numbers. The random numbers r1, r2 and r3 may be generated by three ring oscillators, three pseudo-random binary sequence generators or the like.

The following paragraphs generally provide a detailed description of a scheme that implements an approximate computation of the max* operation in case of four arguments (input values). Cases and implementations with two arguments (input values) may be similar in design and operation.

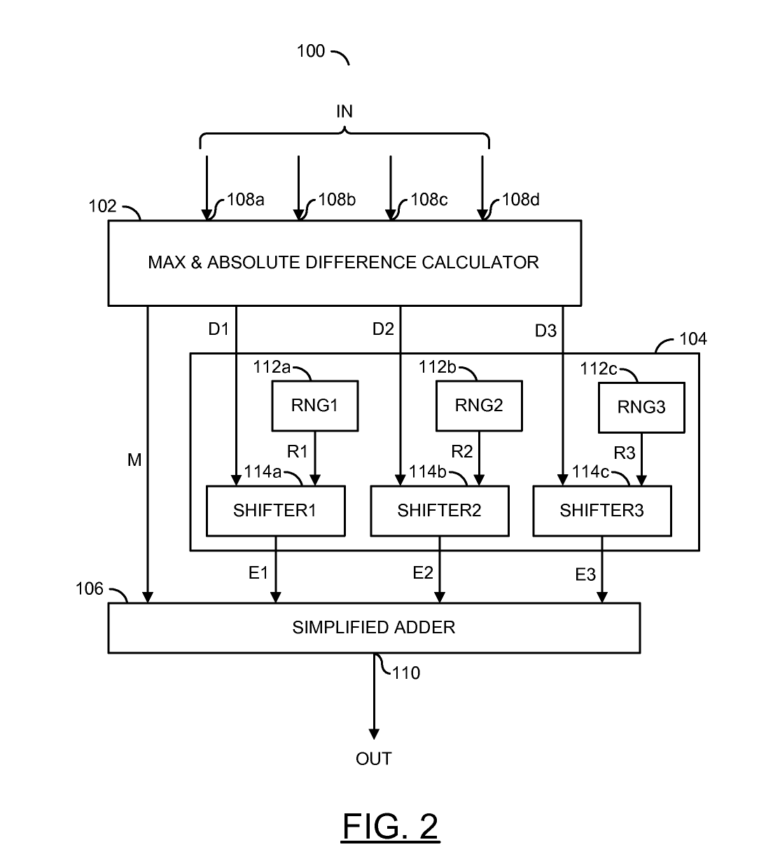

Referring to FIG. 2, a block diagram of an apparatus 100 is shown in accordance with an example embodiment of the present invention. The apparatus (or device or circuit) 100 may operational to compute (calculate) a max* operation to generate an output value based on multiple (e.g., 4) input values. The apparatus 100 generally comprises a circuit (or module) 102, a circuit (or module) 104 and a circuit (or module) 106. The circuits 102 to 106 may represent modules and/or blocks that may be implemented as hardware, firmware, software, a combination of hardware, firmware and/or software, or other implementations. Apparatus 100 may implement a portion of a decoder.

A signal (e.g., IN) may be received by the circuit 102 at multiple input interfaces (e.g., 108a to 108d). The signal IN generally carries multiple input values (e.g., x, y, z and t), a respective input value at each interface 108a to 108d. A signal (e.g., M) may be generated by the circuit 102 and transferred to the circuit 106. The circuit 102 may also generate multiple signals (e.g., D1 to D3), received by the circuit 104. Multiple signals (e.g., E1 to E3) may be generated by the circuit 104 and transferred to the circuit 106. A signal (e.g., OUT) may be generated by the circuit 106 and presented at an output interface 110.

The circuit 102 generally implements a maximum and absolute difference calculator circuit. The circuit 102 may be operational to generate the signal M carrying a maximum value (e.g., m=max(x,y,z,t)) among the input values x, y, z and t, as received in the signal IN. Circuit 102 may also generate the signals D1 to D3. Each signal D1 to D3 may carry a respective truncated value (e.g., [d1], [d2] and [d3]) based on the input values x, y, z and t. In some embodiments, the circuit 102 may be implemented in fully combinational logic such that the delay through the circuit 102 does not include any clocked registers.

The circuit 104 generally implements a random number generator and shift circuit. The circuit 104 may be operational to generate the signals E1 to E3 and multiple random values (e.g., r1, r2 and r3). Each signal E1 to E3 may carry a respective intermediate value (e.g., e1, e2 and e3) based on the absolute difference values and the random values. The intermediate values e1, e2 and e3 may be respective powers of two. Exponents for each power of two may be computed from the absolute difference values, the random values and a unity value (one). The intermediate values may be calculated per formulae 13-15 as follows:

e1=2^{-([d1]+r1+1)} (13)

e2=2^{-([d2]+r2+1)} (14)

e3=2^{-([d3]+r3+1)} (15)

where r1, r2, r3ε{0,1} may be uniformly distributed random numbers. In some embodiments, the circuit 104 may be implemented in fully combinational logic such that the delay through the circuit 104 does not include any clocked registers.

The circuit 106 generally implements an adder circuit. The circuit 106 may be operational to generate the signal OUT by adding the values received in the signals M, E1, E2 and E3. A sum of the maximum value m and the intermediate values e1, e2 and e3 generally results in an approximation of the max* value (e.g., max*(x,y,z,t)). The max* value may be presented at the interface 110 in the signal OUT. In some embodiments, the circuit 106 may be implemented mainly using combinational logic. A clocked register may be included between the combinational logic and the interface 110 to prevent the signal OUT from fluctuating before the combinational logic settles to the final value.

The circuit 104 generally comprises multiple circuits (or modules) 112a to 112c and multiple circuits (or modules) 114a to 114c. The circuits 112a to 114c may represent modules and/or blocks that may be implemented as hardware, firmware, software, a combination of hardware, firmware and/or software, or other implementations.

The signals D1 to D3 may be received by the circuits 114a to 114c respectively. The circuits 114a to 114c may generate the respective signals E1 to E3. Each circuit 112a to 112c may generate a corresponding signal (e.g., R1, R2 and R3) transferred to the circuits 114a to 114c, respectively.

Each circuit 112a to 112c generally implements a random number generator circuit. Circuits 112a to 112c may be operational to generate the random values r1, r2 and r3. The circuits 112a to 112c may generate the corresponding random values independently of each other. The random values r1, r2 and r3 may be transferred to the circuits 114a to 114c in the signals R1, R2 and R3. In some embodiments, each circuit 112a to 112c may be implemented as a stand-alone ring oscillator circuit. In other embodiments, each circuit 112a to 112c may be implemented as a stand-alone pseudo-random binary sequence (PRBS) generator. Other types of random number generators may be implemented to meet the criteria of a particular application.

Each circuit 114a to 114c generally implements a shift circuit. Circuits 114a to 114c may be operational to generate the intermediate values e1, e2 and e3 according to formulae 13-15 based on the truncated values [d1], [d2] and [d3] and the random values r1, r2 and r3. The intermediate values may be presented to the circuit 106 in the corresponding signals E1, E2 and E3. Because all of the arguments (e.g., d1, d2, d3, r1, r2 and r3) may be integers, the circuits 114a to 114c generally calculate the powers of 2 by shifting the bits of the binary values d1, d2 and d3. In a case where ri=1, i={1, 2, 3}, an additional shift to the right for a single digit may be performed. In some embodiments, circuits 114a to 114c may each be implemented in fully combinational logic without any clocked registers.

In binary form, each of the numbers e1, e2 and e3 may contain no more than a single one bit at any given time, with the remaining bits being zeros. The presence of the single one bit generally permits the implementation of a simple adder in the circuit 106 for computing the whole sum. The simplification is generally due to the adder having four arguments and three of the arguments are powers of two.

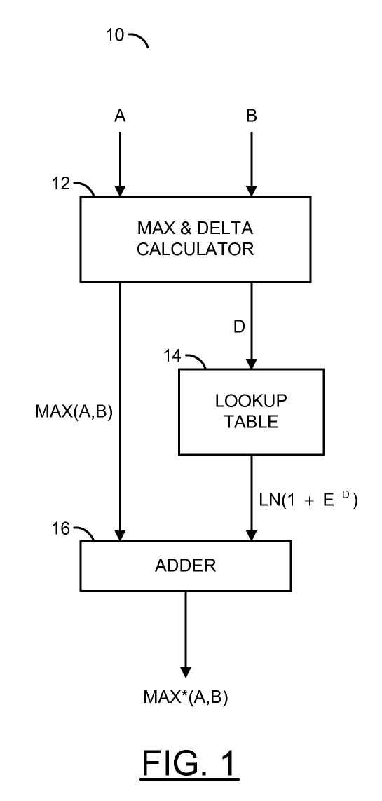

A depth through the apparatus 100 from the input interfaces 108a-108c to the output interface 110 is generally a sum of depths through the individual circuits 102, 104 and 106. Since the circuits 102 and 104 may be implemented with only combinational logic, the resulting scheme may take less than two clock cycles (e.g., a single clock cycle) to process the max* operation. Therefore, the apparatus 100 may have twice the throughput as the circuit 10 in FIG. 1.

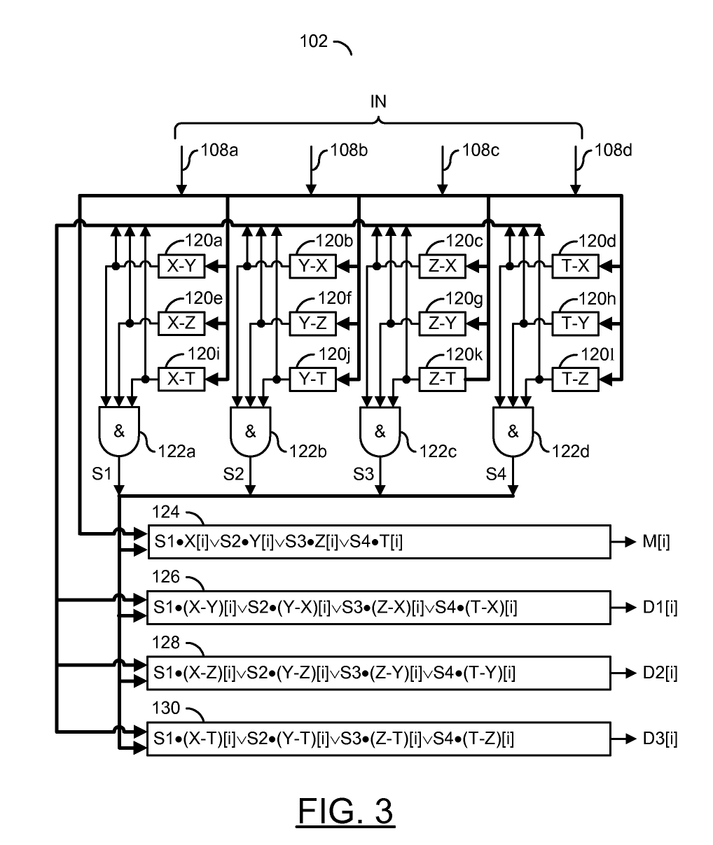

Referring to FIG. 3, a detailed block diagram of an implementation of the circuit 102 is shown. The circuit 102 generally comprises multiple circuits (or modules) 120a to 120l, multiple circuits (or modules) 122a to 122d, a circuit (or module) 124, a circuit (or module) 126, a circuit (or module) 128 and a circuit (or module) 130. The circuits 120a to 130 may represent modules and/or blocks that may be implemented as hardware, firmware, software, a combination of hardware, firmware and/or software, or other implementations.

The signal IN is received by the circuits 120a to 120l and 124 via the input interfaces 108a to 108d. The signal IN generally carries multiple input values (e.g., x, y, z and t), a respective input value at each interface 108a to 108d. Each circuit 120a to 120l generally receives two components of the signal IN (e.g., circuit 120a may receive the components x and y). Circuit 124 receives all of the components of the signal IN. The circuit 124 generates the signal M. The signals D1, D2 and D3 may be generated by the circuits 126, 128 and 130 respectively. Each circuit 120a to 120l may generate a corresponding difference value between the two received input values (e.g., circuit 120a generated a difference value of x−y). The difference values from the input value x may be presented to the circuits 122a, 126, 128 and 130. The difference values from the input value y may be presented to the circuits 122b, 126, 128 and 130. The difference values from the input value z may be presented to the circuits 122c, 126, 128 and 130. The difference values from the input value t may be presented to the circuits 122d, 126, 128 and 130.

Each circuit 120a to 120l generally implements a subtraction circuit. Circuits 120a to 120l may be operational to generate a corresponding difference value by subtracting a given input value from another input value. The difference values may be presented to the circuits 122a to 122d, 126, 128 and 130. The number of circuits 120a to 120l generally depends on the number of components received in the signal IN. For k components (e.g., x, y, z and t), k×(k−1) circuits 120a to 120l are implemented, a respective one for each possible combination of differences.

Each circuit 122a to 122d generally implements a 3-input logical AND circuit. Circuits 122a to 122d may be operational to generate a corresponding sign value (e.g., S1, S2, S3 and S4) based on the difference values received from the circuits 120a to 120l. If all three difference values x−y, x−z and x−t are greater than zero, the circuit 122a may assert the sign value S1 in a logical one or true condition, otherwise the sign value S1 may be asserted in a logical zero of false condition. If all three difference values y−x, y−z and y−t are greater than zero, the circuit 122b may assert the sign value S2 in the logical one or true condition, otherwise the signal value S2 may be asserted in the logical zero or false condition. Similar operations may be performed by the circuits 122c and 122d. The sign values S1, S2, S3 and S4 generally identify the maximum value among the input values x, y, z and t. The sign value corresponding to the largest input value generally has a one value and all of the other sign values may have zero values. The number of circuits 122a to 122d generally depends on the number of components received in the signal IN. For multiple components (e.g., x, y, z and t), a corresponding number of circuits 122a to 122d are implemented, a respective one for each component.

The circuit 124 generally implements a conjunction computation circuit. Circuit 124 may be operational to compute the maximum value max(x,y,z,t) for an i-th set of input values x, y, z and t according to formula 16 as follows:

max(x,y,z,t)[i]=(S1·x[i])V(S2·y[i])V(S3·z[i])V(S4·t[i]) (16)

where “·” may be an AND function and “V” may be an OR function. The maximum value may be presented in the signal M. The circuit 124 may be implemented fully in combinational logic.

The circuit 126 generally implements another conjunction computation circuit. Circuit 126 may be operational to compute the difference value d1 for the i-th set of input values x, y, z and t according to formula 17 as follows:

d1[i]=(S1·(x−y)[i])V(S2·(y−x)[i])V(S3·(z−x)[i])V(S4·(t−x)[i]) (17)

The difference value d1 may be presented in the signal D1. The circuit 126 may be implemented fully in combinational logic.

The circuit 128 generally implements a conjunction computation circuit. Circuit 128 may be operational to compute the difference value dd for the i-th set of input values x, y, z and t according to formula 18 as follows:

d2[i]=(S1·(x−z)[i])V(S2·(y−z)[i])V(S3·(z−y)[i])V(S4·(t−y)[i]) (18)

The difference value d2 may be presented in the signal D2. The circuit 128 may be implemented fully in combinational logic.

The circuit 130 generally implements another conjunction computation circuit. Circuit 130 may be operational to compute the difference value dd for the i-th set of input values x, y, z and t according to formula 19 as follows:

d3[i]=(S1·(x−t)[i])V(S2·(y−t)[i])V(S3·(z−t)[i])V(S4·(t−z)[i]) (19)

The difference value d3 may be presented in the signal D3. The circuit 130 may be fully implemented in combinational logic. A depth of the circuit 102 may be a depth of the subtraction circuits (e.g., 120a) plus 1 logic gate for the AND circuits (e.g., 122a) plus 4 logic gates for the conjunction circuits (e.g., 130).

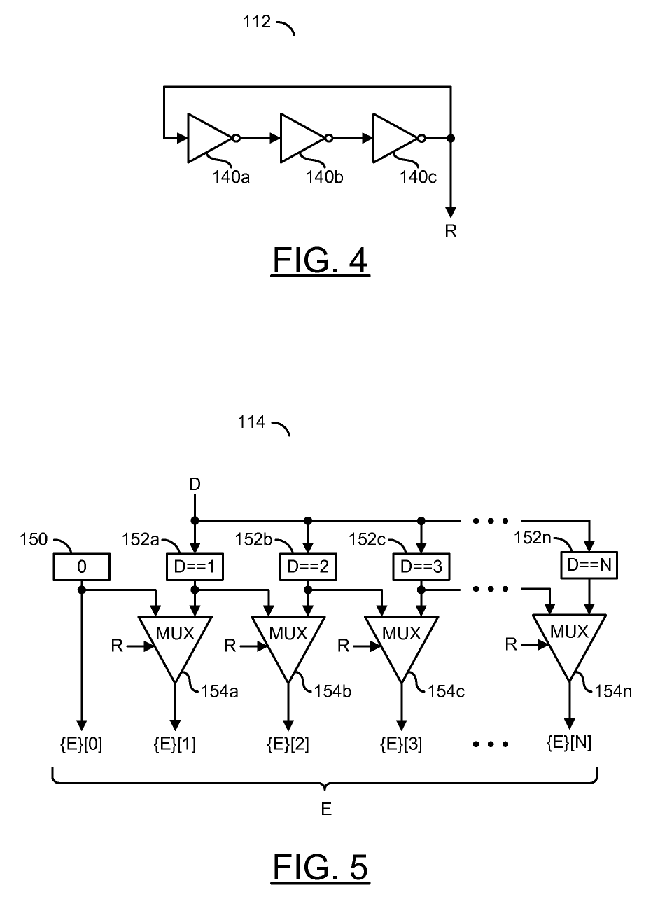

Referring to FIG. 4, a detailed block diagram of an implementation of a circuit 112 is shown. The circuit 112 may implement a ring oscillator circuit. Circuit 112 may be representative of each circuit 112a to 112c in FIG. 2. The circuit 112 generally comprises multiple circuits (or modules) 140a to 140c. Each circuit 140a to 140c may implement a logical NOT gate. The circuits 140a to 140c may represent modules and/or blocks that may be implemented as hardware, firmware, software, a combination of hardware, firmware and/or software, or other implementations.

Circuit 122 generally forms a ring oscillator using an odd number of circuits 140a to 140c connected in the loop. A last circuit (e.g., 140c) in the loop may generate the signal R. The signal R may be presented to the initial circuit (e.g., 140a) in the loop and to the corresponding circuits 114a to 114c in FIG. 2. The signal R may be representative of each signal R1, R2 and R3 in FIG. 2. In operation, the circuit 112 generally toggles the signal R between the zero value and the one value.

In some embodiments, the circuits 112a to 112c may implement PRBS generators. A PRBS usually represents a linear feedback shift register that may be determined by a polynomial. One or more standard polynomials may be implemented, such as X³¹+X²⁸+1. The 31-degree polynomial version of PRBS generator may be created with 31 flip-flops and 2 XOR-gates. Other polynomials may be implemented to meet the criteria of a particular application.

Referring to FIG. 5, a detailed block diagram of an implementation of a circuit 114 is shown. The circuit 114 may implement a shifter circuit. Circuit 114 may be representative of each circuit 114a to 114c in FIG. 2. The circuit 114 generally comprises a circuit (or module) 150, multiple circuits (or modules) 152a to 152n and multiple circuits (or modules) 154a to 154n. The circuits 150 to 154n may represent modules and/or blocks that may be implemented as hardware, firmware, software, a combination of hardware, firmware and/or software, or other implementations.

The circuit 150 generally implements a fixed value circuit. The circuit 150 may be operational to generate a signal (e.g., {E}[0]). The signal {E}[0] conveys a fixed value (e.g., zero value). Notation {E}[i] generally stands for i-th bit (fractional part) of a signal (e.g., E). Signal E is representative of the signals E1, E2 and E3 in FIG. 2. The fixed value is determined such that the signal E represents a fractional value between zero and one.

Each circuit 152a to 152n generally implements an equalizer circuit. Circuits 152a to 152n may be operational to compare (equate) an absolute difference value (e.g., d) received in a signal (e.g., D) to a predetermined integer value (e.g., 1, 2, 3, . . . ). The value d in the signal D may be representative of each of the values d1, d2 and d3 in the signals D1, D2 and D3 respectively. If the value d matches the predetermined integer value (e.g., d=1 in the circuit 152a), the one value may be presented to both a corresponding and a next neighboring circuit 154a to 154n, otherwise the zero value may be presented. The last circuit 152n may present the results just to the corresponding circuit 154n. The number of circuits 152a to 152n is generally limited by the maximum possible absolute value d generated by the circuit 102.

Each circuit 154a to 154n generally, implements a 2:1 multiplexer circuit. Circuits 154b to 154n may be operational to route the results from either a corresponding or a previous neighboring circuit 152a to 152n in response to the random value r in the signal R. Initial circuit 154a may select between the corresponding circuit 152a and the circuit 150. The random value r in the signal R may be representative of the random values r1, r2 and r3 in the signals R1, R2 and R3 respectively in FIG. 2. Each circuit 154a to 154n may present the routed values in a signal (e.g., {E}[1] to {E}[N]). A combination of the signals {E}[0] to {E}[N] may form the signal E. Circuit 114 may compute only fractional parts of the intermediate value e because the integer part (e.g., {E}[0]) may always be zero. Depth of the circuit 114 may be the depth of an equalizer circuit (e.g., 152a) plus the depth of a multiplexer circuit (e.g., 154a). The circuit 112 may be implemented in fully combinational logic.

Some embodiments of the present invention may provides schemes that compute approximations of the max* operation. The schemes generally have small depths that make possible high clock frequencies applications. Thus, the schemes may be suitable to implement the Log-MAP decoding technique at high clock frequencies and high data rates. Moreover, the schemes may support the emerging standard WiMAX that calls for a four-operand max* operation, whereas the other standards may use two variable max* operations. The approximation may provide decoding quality comparable with quality of pure Log-MAP decoding techniques.

The schemes generally provide high decoding quality and speed at the same time. Usage of ring oscillators and/or other random number/sequence generators may increase decoding quality in cases where fixed point numbers are used. Furthermore, the circuit 102 may calculate a maximum value and multiple (e.g., 3) additive term values in only combinational logic allowing decreased overall depth of the scheme.

The functions performed by the diagrams of FIGS. 2-5 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

As would be apparent to those skilled in the relevant art(s), the signals illustrated in FIGS. 2-5 represent logical data flows. The logical data flows are generally representative of physical data transferred between the respective blocks by, for example, address, data, and control signals and/or busses. The system represented by the apparatus 100 may be implemented in hardware, software or a combination of hardware and software according to the teachings of the present disclosure, as would be apparent to those skilled in the relevant art(s).

While the invention has been particularly shown and described with reference to the preferred embodiments thereof, it will be understood by those skilled in the art that various changes in form and details may be made without departing from the scope of the invention.

1. An apparatus comprising:
a first circuit configured to generate a plurality of first signals carrying (i) a maximum value among a plurality of input values and (ii) a plurality of difference values based on said input values;
a second circuit configured to generate a plurality of second signals carrying a plurality of intermediate values based on said difference values, wherein said intermediate values are respective powers of two; and
a third circuit configured to generate a third signal carrying an output value by adding said maximum value and said intermediate values, wherein said output value is a Jacobian logarithm computation of said input values.

2. The apparatus according to claim 1, wherein a delay between receipt of said input values and calculation of said output value is less than two clock cycles of said apparatus.

3. The apparatus according to claim 1, wherein said second circuit is further configured to calculate exponents of said respective powers of two, said exponents comprising said difference values plus one.

4. The apparatus according to claim 3, wherein said second circuit is further configured to generate a plurality of random values.

5. The apparatus according to claim 4, wherein said exponents further comprise said random values.

6. The apparatus according to claim 4, wherein each of said random values is an element of a set of zero and one.

7. The apparatus according to claim 1, wherein said first circuit is further configured to truncate said difference values to integers.

8. The apparatus according to claim 1, wherein said first circuit and said second circuit are fully implemented in combinational logic.

9. The apparatus according to claim 1, wherein said Jacobian logarithm computation is defined as max*(a,b)=ln(e^{a}+e^{b}), where a and b are said input values.

10. The apparatus according to claim 1, wherein said apparatus is implemented as one or more integrated circuits.

11. A method for computation of a Jacobian logarithm in an apparatus, comprising the steps of:
(A) generating a plurality of first signals carrying (i) a maximum value among a plurality of input values and (ii) a plurality of difference values based on said input values;
(B) generating a plurality of second signals carrying a plurality of intermediate values based on said difference values, wherein said intermediate values are respective powers of two; and
(C) generating a third signal carrying an output value by adding said maximum value and said intermediate values.

12. The method according to claim 11, wherein a delay between receipt of said input values and calculation of said output value is less than two clock cycles of said apparatus.

13. The method according to claim 11, further comprising the step of:
calculating exponents of said respective powers of two, said exponents comprising said difference values plus one.

14. The method according to claim 13, further comprising the step of:
generating a plurality of random values.

15. The method according to claim 14, wherein said exponents further comprise said random values.

16. The method according to claim 14, wherein each of said random values is an element of a set of zero and one.

17. The method according to claim 11, further comprising the step of:
truncating said difference values to integers prior to generating said second signals.

18. The method according to claim 11, wherein said generation of said first signals and said generation of said second signals are fully performed in combinational logic.

19. The method according to claim 11, wherein said input values comprise four input values.

20. An apparatus comprising:
means for generating a plurality of first signals carrying (i) a maximum value among a plurality of input values and (ii) a plurality of difference values based on said input values;
means for generating a plurality of second signals carrying a plurality of intermediate values based on said difference values, wherein said intermediate values are respective powers of two; and
means for generating a third signal carrying an output value by adding said maximum value and said intermediate values, wherein said output value is a Jacobian logarithm computation of said input values.
